(19) United States
(12) Patent Application Publication
(10) Pub. No.: US 2023/0079352 A1
(43) Pub. Date: Mar. 16, 2023

(54) PROTECTION STRUCTURE FOR FUEL PUMP CONNECTION PART

(71) Applicant: HONDA MOTOR CO., LTD., MINATO-KU, TOKYO (JP)

(72) Inventors: Kiyoshige SAITO, WAKO-SHI, SAITAMA (JP); Akihiro TAGUCHI, WAKO-SHI, SAITAMA (JP)

(21) Appl. No.: 17/799,676

(22) PCT Filed: Jan. 26, 2021
(86) PCT No.: PCT/JP2021/002679

§ 371 Date: Aug. 14, 2022

(30) Foreign Application Priority Data
Mar. 11, 2020 (JP) 2020-042242

(51) Int. Cl. F02M 37/10; F02M 37/04

(52) U.S. Cl. CPC F02M 37/103; F02M 37/04

(57) ABSTRACT

A protection structure for the fuel pump connection part includes a top plate 20 that has fuel pump connection parts 23, 25, and a cover member 30 that covers the top plate 20 and the fuel pump connection parts 23, 25. The cover member 30 includes a top plate cover part 31, hole parts 39, 41, and connection-part cover parts 45, 55. The top plate cover part 31 and the connection-part cover parts 45, 55 are integrally formed. The connection-part cover parts 45, 55 includes movable parts 47, 57 that move with respect to the top plate cover part 31, and the fuel pump connection parts 23, 25 are exposed in a state where the movable parts 47, 57 have moved in a separating direction from a front surface side of the top plate cover part 31.

### TECHNICAL FIELD

The present invention relates to a protection structure for protecting a fuel pump connection part of a connection member connected to a fuel pump disposed in a fuel tank via the fuel pump connection part.

### BACKGROUND ART

To a fuel pump disposed inside a fuel tank of a vehicle are connected connection members such as a tube that supplies a fuel to an internal combustion engine and wiring for supplying electric power to the fuel pump. These are connected to the fuel pump via the fuel pump connection part provided on a top plate covering an opening part of the fuel tank.

The above-described top plate and fuel pump connection part are often formed of resin. When a liquid containing a strong acid, such as a vehicle cleaning liquid, a rust removing agent, or a brake cleaner, adheres to these, the resin may be deteriorated. Therefore, it is conceivable to cover the top plate and the fuel pump connection part with an acid-resistant cover.

For example, Patent Literature 1 below describes a fuel supply device including: an attachment part that covers an opening part formed in an upper part of a tank and has a fuel discharge pipe and an electric connector disposed; and a cover that has a substantially dome shape and has a flange part formed on four sides of the cover. This cover is attached to the attachment part via a plurality of fitting protruding parts to cover the electric connector.

### CITATION LIST

### Patent Literature

Patent Literature 1: JP 2007-303347 A

### SUMMARY OF INVENTION

### Technical Problem

While in the invention of Patent Literature 1, only the electric connector is covered with the cover, it is desirable that the top plate and a connection pipe other than the electric connector are also covered with the cover.

However, in a case where in order to cover the connection part, an integral cover that covers the top plate and the connection part is to be attached after the connector is connected, it is necessary to attach the cover so as to avoid the connected connector and the like, and the attachment of the cover is complicated. Moreover, when a cover that covers the top plate before connection and a cover that covers the connection part after connection are separately prepared, a number of parts and a number of processes increase, and in this case, attachment of the covers is also complicated.

Furthermore, since the covers that covers each of the members is a separate body, a gap is generated between the covers. Therefore, there is a risk that from the gap, a liquid such as a vehicle cleaning liquid flows into, for example, between the cover and the top plate.

Therefore, an object of the present invention is to provide a protection structure for a fuel pump connection part that enables a cover member to be easily attached to a top plate or the fuel pump connection part, can protect the fuel pump connection part, and can suppress inflow of liquid.

### Solution to Problem

In order to achieve the above object, the present invention provides a protection structure for protecting a fuel pump connection part of a connection member connected to a fuel pump disposed inside a fuel tank via the fuel pump connection part, the protection structure including: a top plate that covers an opening part of the fuel tank and includes the fuel pump connection part; and a cover member that covers the top plate and the fuel pump connection part, wherein the cover member includes a top plate cover part that covers the top plate, a hole part that is formed in this top plate cover part and through which the fuel pump connection part protrudes, and a connection-part cover part that extends from this hole part so as to cover the fuel pump connection part and the connection member connected to the fuel pump connection part, the top plate cover part and the connection-part cover part are integrally formed, and the connection-part cover part includes a movable part movable in a separating direction and an approaching direction with respect to a front surface side of the top plate cover part, and the fuel pump connection part is exposed in a state where this movable part has moved in the separating direction from the front surface side of the top plate cover part.

According to the above invention, after the cover member is attached and covers the top plate and the fuel pump connection part in a state where the fuel pump connection part protrudes from the hole part of the cover member, the movable part of the connection-part cover part is moved in the separating direction from the front surface side of the top plate cover part to expose the fuel pump connection part, which makes it possible to connect the connection member to the fuel pump connection part. Therefore, the cover member can be easily attached as compared with a case where the top plate cover part and the connection-part cover part are separate bodies and are separately attached.

Moreover, after the connection member is connected to the fuel pump connection part, the movable part is moved in the approaching direction with respect to the front surface side of the top plate cover part, which makes it possible to cover the fuel pump connection part and the connection member with the connection-part cover part. Therefore, the fuel pump connection part can be protected, and inflow of a liquid such as a cleaning liquid can be suppressed.

In the protection structure for the fuel pump connection part of the present invention, it is preferable that a wall part having a height higher than a height of a front surface of the top plate cover part is erected on a front-side peripheral edge of the hole part.

According to the above aspect, since the wall part having a height higher than the height of the front surface of the top plate cover part is erected on the front-side peripheral edge of the hole part, even if liquid attempts to flow into the hole part from a gap between the movable part and the top plate cover part, the liquid can be blocked by the wall part, so that the inflow of the liquid into the hole part can be suppressed.

In the protection structure for the fuel pump connection part of the present invention, it is preferable that the connection-part cover part includes a fixed part fixed to the top plate cover part, and a fragile part having a lower rigidity than the fixed part and the movable part is provided between the fixed part and the movable part.

According to this aspect, when the movable part is moved in the separating direction from the front surface side of the top plate cover part, the movable part can be moved with respect to the fixed part via the fragile part having a lower rigidity, the movable part can be easily moved, and the connection workability of the connection member with respect to the fuel pump connection part can be enhanced.

In the protection structure for the fuel pump connection part of the present invention, it is preferable that at least the movable part is formed of an elastic material. According to this aspect, the movable part can be moved in the separating direction from the front surface side of the top cover part so as to be turned up by using elasticity, and the fuel pump connection part can be easily exposed.

In the protection structure for the fuel pump connection part of the present invention, it is preferable that the top plate cover part is disposed with a gap interposed with respect to the top plate, and a rib extending toward the top plate and abutting on a front surface side of the top plate is provided on a back surface side of the top plate cover part and in a vicinity of the wall part.

According to this aspect, since the rib extending toward the top plate and abutting on the front side of the top plate is provided in the vicinity of the wall part on the back side of the top plate cover part, even if the vicinity of the wall part is pressed by an external force or the like, the rib abuts on the front surface side of the top plate, which makes it possible to suppress the deformation of the wall part by receiving an external force or the like, and more surely suppress the inflow of liquid into the hole part.

### Advantageous Effects of Invention

According to the present invention, after the cover member is attached to the top plate, the movable part of the connection-part cover part is moved in the separating direction from the front surface side of the top plate cover part to expose the fuel pump connection part, which makes it possible to connect the connection member to the fuel pump connection part. Therefore, the cover member can be easily attached as compared with the case where the top plate cover part and the connection part cover part are separate bodies. Moreover, after the connection member is connected to the fuel pump connection part, the movable part is moved to the front surface side of the top plate cover part, which makes it possible to protect the fuel pump connection part and suppress inflow of a liquid such as a cleaning liquid can be suppressed.

### BRIEF DESCRIPTION OF DRAWINGS

FIG. 1 is a perspective view illustrating one embodiment of a protection structure for a fuel pump connection part according to the present invention in a state before a cover member is attached to a top plate.

FIG. 2 is a perspective view of the same protection structure in a state where the cover member is attached to the top plate.

FIG. 3 is an enlarged cross-sectional perspective view of a main section of the same protection structure.

FIG. 4 is an enlarged cross-sectional view of the main section of the same protection structure.

FIG. 5 is a cross-sectional view taken along a horizontal direction in the vicinity of a first connection-part cover part of the same protection structure.

FIG. 6 is an explanatory view illustrating a state before a connection member is connected to the first fuel pump connection part in the same protection structure.

FIG. 7 is an explanatory view illustrating a state where the connection member is connected to the first fuel pump connection part in the same protection structure.

FIG. 8 is an explanatory view of the same protection structure in the vicinity of a peripheral edge part of the cover member attached to the top plate.

FIG. 9 is a traverse section view on a distal end side in an extension direction of the first connection-part cover part and a second connection-part cover part in the same protection structure.

### DESCRIPTION OF EMBODIMENTS

Hereinafter, one embodiment of a protection structure for a fuel pump attachment part according to the present invention will be described with reference to the drawings.

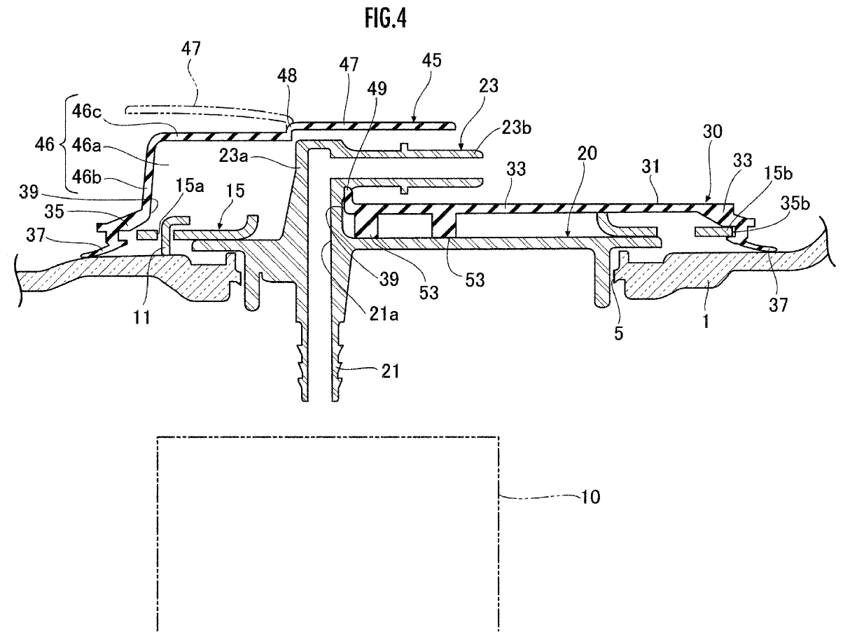

As illustrated in FIG. 4, a fuel pump 10 for feeding fuel to an internal combustion engine or the like is disposed inside a fuel tank 1 having a predetermined shape. An opening part 5 having a predetermined shape is formed in an upper wall of the fuel tank 1. A top plate 20 is attached to this opening part 5, and the opening part 5 is covered with the top plate 20. Further, the top plate 20 is provided with a first fuel pump connection part 23 (hereinafter, also simply referred to as a “first connection part 23”) and a fuel pump connection part 25 (hereinafter, also simply referred to as a “second connection part 25”).

A connector 7 connected to one end of a tube 8 joined to the internal combustion engine or the like is connected to the first connection part 23. Moreover, as illustrated in FIG. 4, a through hole 21a is formed at a predetermined position of the top plate 20, and a pump connection pipe 21 hangs down from a back-side peripheral edge of this through hole 21a. By connecting a connection pipe (not illustrated) to this pump connection pipe 21, the fuel pump 10 and the first connection part 23 are connected to each other via the connection pipe (not illustrated).

On the other hand, to the second connection part 25 is connected an electric connector (not illustrated) joined to electric supply wiring to the fuel pump 10. Moreover, the fuel pump 10 and the second connection part 25 are electrically connected via wiring (not illustrated).

The above-described connector 7 and the electric connector (not illustrated) constitute a “connection member” in the present invention. Note that a checker 7a that can be removed when connection with the first connection part 23 is completed is mounted on an outer periphery of the connector 7.

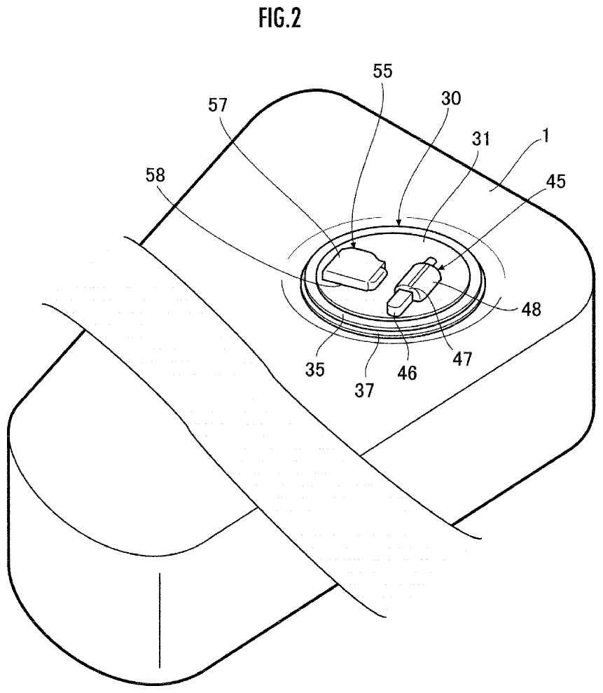

As illustrated in FIGS. 2 to 4, the protection structure for the fuel pump connection part (hereinafter, also simply referred to as a “protection structure”) of the present invention is for protecting the fuel pump connection parts 23, 25 as described above, and has the top plate 20 that covers the opening part 5 of the fuel tank 1 and has the fuel pump connection parts 23, 25, and a cover member 30 that covers the top plate 20 and the fuel pump connection parts 23, 25.

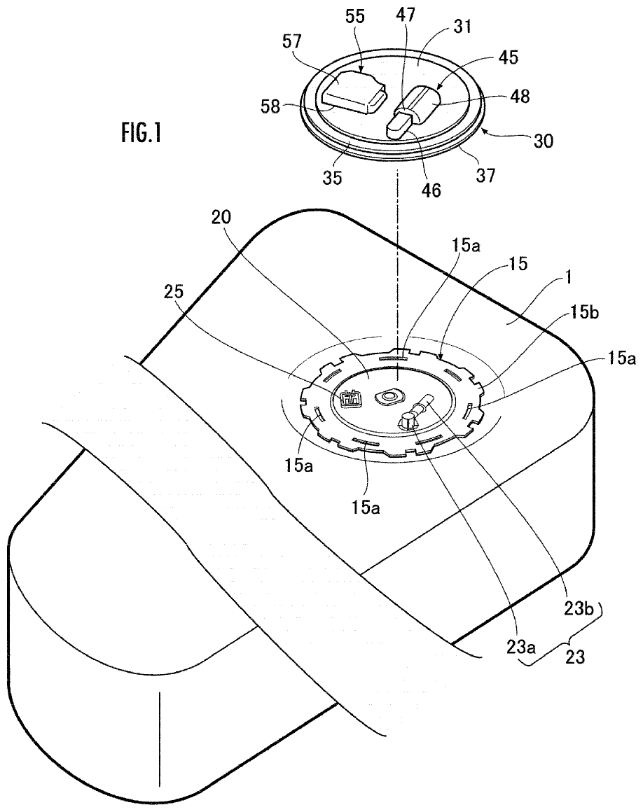

As illustrated in FIG. 4, a plurality of frame mounting claws 11 are provided in a protruding manner from a peripheral edge of the opening part 5. An annular frame 15 made of a metal is mounted on the plurality of frame mounting claws 11 (see FIG. 1). This annular frame 15 is disposed on a front-side peripheral edge of the top plate 20 and presses the top plate 20 to suppress detachment of the top plate 20 from the opening part 5. Moreover, in the annular frame 15, a plurality of grooves 15a are formed along a peripheral direction (see FIG. 1).

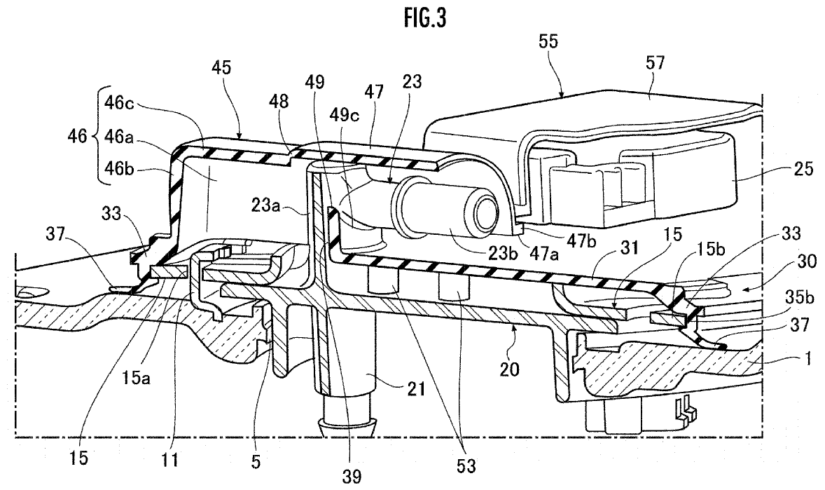

By inserting the plurality of frame mounting claws 11 into the plurality of grooves 15a, respectively, and rotating the annular frame 15 in a predetermined direction, each of the frame mounting claws 11 is engaged with each of the grooves 15a, so that the annular frame 15 is mounted in a state being retained so as to prevent coming-off (see FIGS. 3 and 4).

While as described above, the cover member 30 of this embodiment is indirectly attached to the top plate 20 via the annular frame 15, the cover member 30 may be directly attached to the top plate 20.

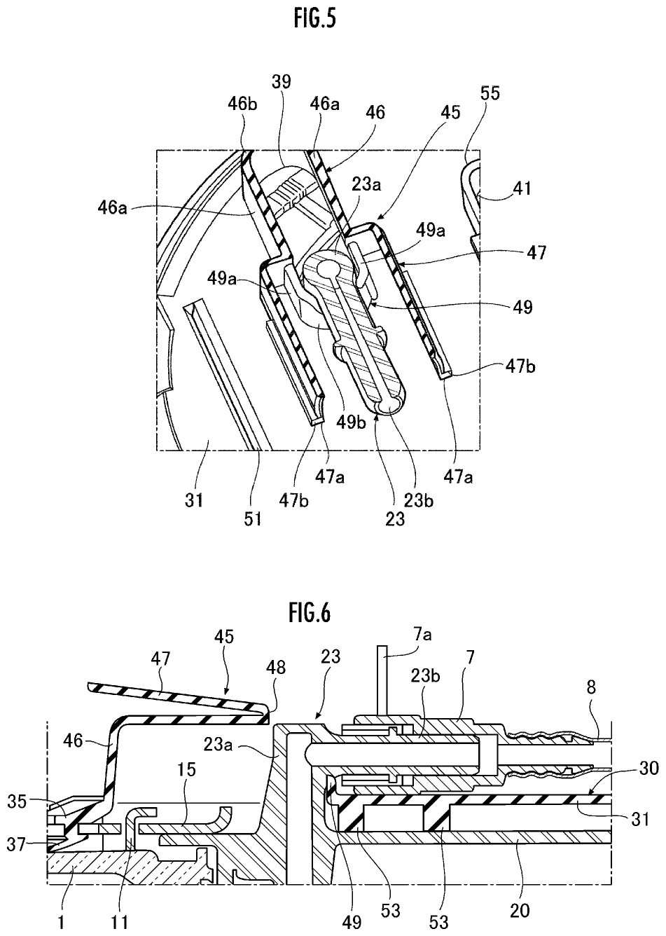

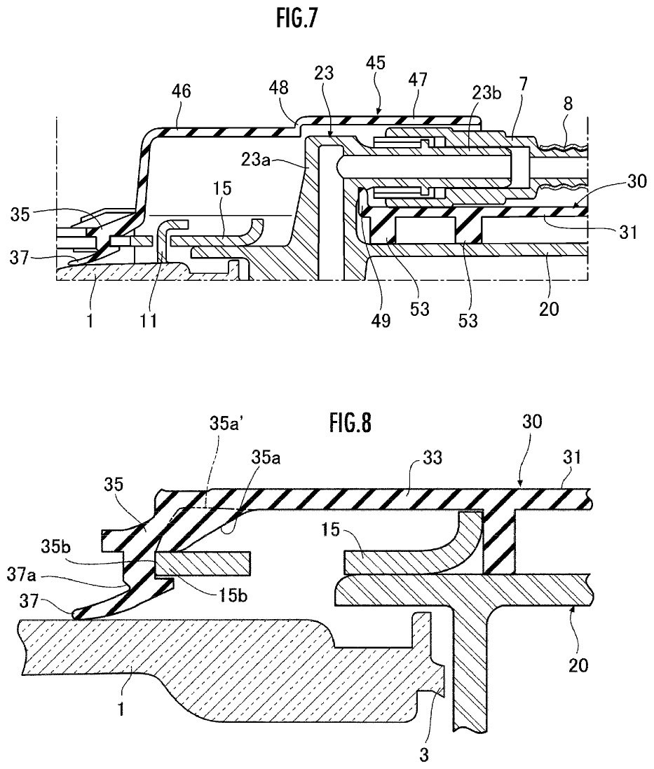

Moreover, the first connection part 23 that is substantially L-shaped and tubular is provided at a position of the top plate 20 that is aligned with the pump connection pipe 21. This first connection part 23 includes a base part 23a that is provided in a protruding manner from a front-side peripheral edge of the through hole 21a, and an extension part 23b extending in a horizontal direction from an upper end of this base part 23a. As illustrated in FIGS. 6 and 7, the connector 7 as the connection member is connected to the extension part 23b.

Further, as shown in FIG. 3, the second connection part 25 having a substantially square frame shape is provided at a position of the top plate 20 adjacent to the first connection part 23. As described above, to the second connection part 25 are connected the electric connector (not illustrated) joined to the electric supply wiring to the fuel pump 10, and the like.

Note that the shapes and the structures of the top plate and the fuel pump connection part are not limited to the aspect described above. Moreover, while this top plate is provided with the two fuel pump connection parts, a number of the fuel pump connection parts may be one, or may be three or more.

Next, the cover member 30 will be described.

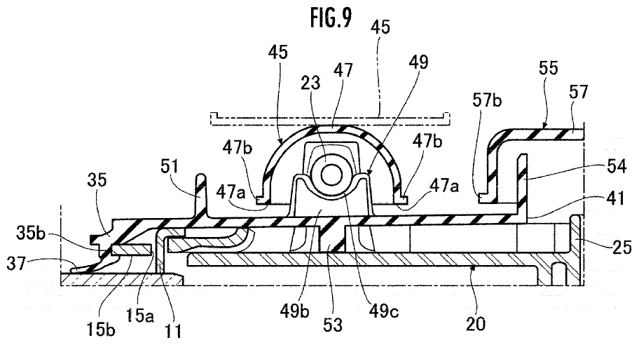

As illustrated in FIGS. 2 and 3, this cover member 30 includes a top plate cover part 31 having a substantially disk shape so as to cover the top plate 20. Referring also to FIG. 8, this top plate cover part 31 includes a base part 33 formed in a constant thickness, and a peripheral edge part 35 formed on an outer periphery of the base part 33 and formed to be thicker than the base part 33. An inner periphery 35a of the peripheral edge part 35 has a shape gradually increasing in thickness toward an outer diameter direction from a boundary part with the base part 33. As a result, a rigidity of the top plate cover part 31 increases toward an outer diameter side. Moreover, as described above, since the inner periphery 35a of the peripheral edge part 35 is made thick, a length on an inner surface side of the top plate cover part 31 is longer than a length of an inner periphery 35a′ that is not thick.

Moreover, a fitting recessed part 35b having an annular recessed shape is formed inside the peripheral edge part 35, and an outer peripheral edge part 15b of the annular frame 15 is fitted into this fitting recessed part 35b. As a result, as illustrated in FIGS. 3 and 4, the cover member 30 is attached to the top plate 20 via the annular frame 15. At this time, the top plate cover part 31 is disposed with respect to the top plate 20 with a gap interposed therebetween (see FIG. 4).

Further, a seal flange 37 extends obliquely outward from a back-side outer periphery of the peripheral edge part 35. As described above, when the cover member 30 is attached to the top plate 20 via the annular frame 15, the seal flange 37 elastically abuts (abuts in an elastically deformed state) on a surface of the fuel tank 1. As a result, a gap between the cover member 30 and the surface of the fuel tank 1 is sealed, and sealing performance is improved.

Moreover, as illustrated in FIG. 8, a notch 37a is formed on an outer periphery of a base end part of the seal flange 37. Since this notch 37a is provided, a reaction force received from the tank surface when the seal flange 37 abuts on the surface of the fuel tank 1 is reduced, and the seal flange 37 is easily elastically deformed.

Moreover, as illustrated in FIGS. 4 and 5, a first hole part 39 having a substantially rectangular elongated hole shape is formed at a position of the top plate cover part 31 that is aligned with the first connection part 23 formed on the top plate 20. Further, a second hole part 41 having a substantially square hole shape is formed at a position of the top plate cover part 31 that is aligned with the second connection part 25 provided on the top plate 20 (see FIGS. 5 and 9). In a state where the cover member 30 is attached to the top plate 20, the first connection part 23 protrudes from the first hole part 39, and the second connection part 25 protrudes from the second hole part 41.

Moreover, a first connection-part cover part 45 (hereinafter, also simply referred to as a “first cover part 45”) is extended from a front-side peripheral edge of the first hole part 39 so as to cover the first connection part 23 and the connector 7 connected thereto. On the other hand, a second connection-part cover part 55 (hereinafter, also simply referred to as a “second cover part 55”) is extended from a front-side peripheral edge of the second hole part 41 so as to cover the second connection part 25 and the connection member (not illustrated) (here, the above-mentioned electric connector) connected thereto.

The cover parts 45, 55 respectively have movable parts 47, 57 that are movable in a separating direction and an approaching direction with respect to a front surface side of the top plate cover part 31. In a state where the movable parts 47, 57 have moved from the front surface side of the top plate cover part 31, the first connection part 23 and the second connection part 25 are exposed, and the connection members can be connected.

Moreover, the first cover part 45 has a fixed part 46 fixed to the top plate cover part 31, and a fragile part 48 having a lower rigidity than the fixed part 46 and the movable part 47 is provided between the fixed part 46 and the movable part 47.

More specifically, as illustrated in FIGS. 3 to 5, the fixed part 46 of the first cover part 45 in this embodiment is constituted of a pair of side walls 46a, 46a erected from both side peripheral edges in a longitudinal direction of the first hole part 39, an end wall 46b joining one-ends in the longitudinal direction of the side walls 46a, 46a to each other, and a ceiling wall 46c joining the side walls 46a, 46a and the end wall 46b to each other, and has a substantially rectangular frame shape that surrounds the first hole part 39 and has another end side in the longitudinal direction opened.

Moreover, on the other end side (opening side) in the longitudinal direction of the fixed part 46, the fragile part 48 having a thickness thinner than thicknesses of the fixed part 46 and the movable part 47 is disposed, and the movable part 47 is provided continuously to the other end side in the longitudinal direction of the fixed part 46 via this fragile part 48. As illustrated in FIGS. 2 and 5, the movable part 47 of this embodiment has a substantially semi-cylindrical shape extending by a predetermined length with a semicircular cross-sectional shape slightly larger than a transverse cross-sectional shape of the fixed part 46, and a distal end side in an extension direction is opened.

Moreover, as illustrated in FIG. 9, both-side end surfaces 47a, 47a of the movable part 47 are separated from a front surface of the top plate cover part 31, so that the movable part 47 is movable. Further, flange parts 47b, 47b are provided in a protruding manner from an outside of the both-side end surfaces 47a, 47a of movable part 47. These flange parts 47b, 47b facilitate gripping and movement of the movable part 47 and increase rigidity of the movable part 47 itself.

Then, in this first cover part 45, when the movable part 47 is moved in the direction separating from the front surface of the top plate cover part 31, the movable part 47 is elastically deformed and turned up so as to have a flat shape as illustrated in FIG. 9 with respect to the fixed part 46 via the fragile part 48, and when the movable part 47 is further moved in a direction approaching the fixed part 46, as illustrated in FIG. 6, the movable part 47 is moved so as to be folded back and the first connection part 23 is exposed.

Moreover, as illustrated in FIG. 5, a wall part 49 having a height higher than the front surface of the top plate cover part 31 is erected on the front-side peripheral edge of the first hole part 39. The wall part 49 of this embodiment is constituted of a pair of extension walls 49a, 49a extending from the other end side (opening side) in the longitudinal direction of the pair of side walls 46a, 46a constituting the fixed part 46 toward the extension direction of the movable part 47, and a joining wall 49b joining dismal ends of this pair of extension walls 49a, 49a in the extension direction, and has a frame shape surrounding the base part 23a of the first connection part 23. Further, as shown in FIG. 9, a groove part 49c having an arc shape adapted to an outer peripheral shape (circular shape) of the extension part 23b of the first connection part 23 is formed in an upper edge part of the joining wall 49b.

Further, as shown in FIG. 9, on the front surface side of the top plate cover part 31 and on one side of the movable part 47 of the first cover part 45, a side wall part 51 extending in parallel along an extension direction of the first cover part 45 is erected at an interval that does not interfere when the movable part 47 is deformed to have a flat shape. The side wall part 51 restrains a liquid such as a cleaning liquid from flowing into a gap between the movable part 47 of the first cover part 45 and the top plate cover part 31, and does not interfere when the movable part 47 is deformed into a flat shape (see FIG. 9), and does not hinder the moving operation of the movable part 47.

Moreover, as described above, the top plate cover part 31 is disposed with respect to the top plate 20 with the gap interposed therebetween (see FIG. 4), and ribs 53 extending toward the top plate 20 and abutting on a front surface side of the top plate 20 are provided on a back surface side of the top plate cover part 31 and in the vicinity of the wall part 49. As shown in FIG. 4, in this embodiment, one of the ribs 53 is vertically provided from a position closest to the wall part 49 on the back surface side of the top plate cover part 31, and the other rib 53 is vertically provided from a position away from the foregoing rib 53 by a predetermined length.

On the other hand, the second cover part 55 in this embodiment has a substantially square cover shape opened in the same direction as the opening of the first cover part 45 in the extension direction. In this embodiment, as shown in FIG. 9, a frame-shaped inner cover 54 is erected from the front-side peripheral edge of the second hole part 41 having a substantially square hole shape, and the second cover part 55 is disposed outside the inner cover 54. The second cover part 55 has a movable part 57 having a square frame shape with one side part opened, and a base end part 58 thereof is joined to the top plate cover part 31. Moreover, flange parts 57b, 57b that facilitate movement of the movable part 57 and enhance rigidity are provided in a protruding manner from an outside of both-side end surfaces 57a, 57a of the movable part 57 similarly to the flange parts 47b of the first cover part 45.

In the second connection-part cover part 55, when the movable part 57 is moved in the direction separating from the front surface of the top plate cover part 31, the movable part 57 is elastically deformed so as to be turned up via the base end part 58, and the second connection part 25 is exposed.

Moreover, as illustrated in FIG. 9, the second cover part 55 is disposed on the side of the first cover part 45 at an interval that prevents interference when the movable part 47 of the first cover part 45 moves so as to form a flat shape. Therefore, when the movable part 47 is deformed to have a flat shape, it is prevented from interfering with the second cover part 55, and the moving work of the movable part 47 is not hindered.

The top plate cover part 31, the first cover part 45, and the second cover part 55 described above are integrally formed. In this embodiment, all the parts (top plate cover part, both the cover parts, and the like) constituting the cover member 30 are integrally formed of an elastic material such as rubber. Note that the cover member may be formed of a synthetic resin material such as polyethylene (PE) or polyoxymethylene (POM) in addition to the foregoing elastic material. However, in the cover member 30, at least the movable parts 47, 57 are preferably formed of an elastic material. Moreover, the cover member is preferably formed of a material having excellent acid resistance such as rubber (EPDM, MBR).

Moreover, the shapes and the structures of the top plate cover part, the hole parts, and the connection-part cover parts of the cover member described above are not limited to the above aspects. Note that while in the cover member of this embodiment, the two hole parts and the two connection-part cover parts are provided, it is possible to provide one or three or more hole parts and connection-part cover parts corresponding to the fuel pump connection part provided on the top plate side.

Next, actions and effects of the protection structure having the above constitution will be described.

In this embodiment, as shown in FIG. 1, the cover member 30 is attached to the top plate 20 via the annular frame 15 from a state where the annular frame 15 is retained by the plurality of frame mounting claws 11 so as to prevent coming-off and is mounted, the plurality of frame mounting claws being provided at the peripheral edge of the opening part 5. That is, after the first cover part 45 and the second cover part 55 of the cover member 30 are aligned with the first connection part 23 and the second connection part 25 of the top plate 20, the cover member 30 is pushed into the top plate 20.

Then, the first connection part 23 and the second connection part 25 of the top plate 20 protrude from the first hole part 39 and the second hole part 41 of the cover member 30, respectively, and the seal flange 37 of the cover member 30 abuts on the surface of the fuel tank 1 and is flexurally deformed. Further, the outer peripheral edge part 15b of the annular frame 15 presses the back side of the peripheral edge part 35 of the top plate cover part 31, and the peripheral edge part 35 is flexurally deformed so as to warp toward an outside of the front side of the top plate cover part 31.

At this time, as illustrated in FIG. 8, in the top plate cover part 31 in this embodiment, the inner periphery 35a of the peripheral edge part 35 gradually becomes thicker in the outer diameter direction, the rigidity of the top plate cover part 31 increases toward the outer diameter side, and the length on the inner surface side of the top plate cover part 31 is longer than the length of the inner periphery 35a′ that is not thick. Therefore, when the cover member 30 is pushed into the top plate 20, by pushing a vicinity of a boundary between the base part 33 and the peripheral edge part 35 of the top plate cover part 31, the peripheral edge part 35 can be easily flexurally deformed toward an outside of the front side of the top plate cover part 31.

Further, when the cover member 30 is pushed into the top plate 20, the outer peripheral edge part 15b of the annular frame 15 enters and fits into the fitting recessed part 35b of the cover member 30, and the peripheral edge part 35 elastically returns to the base part 33, so that the cover member 30 can be attached to the top plate 20 via the annular frame 15 as illustrated in FIGS. 3 and 4.

In the above state, the top plate 20 is covered with the top plate cover part 31, the first connection part 23 of the top plate 20 protruding from the first hole part 39 of the cover member 30 is covered with the first cover part 45, and further, the second connection part 25 of the top plate 20 protruding from the second hole part 41 of the cover member 30 is covered with the second cover part 55. Note that in this state, the extension part 23b of the first connection part 23 is supported by the groove part 49c of the joining wall 49b of the wall part 49 (see FIG. 9), and the plurality of ribs 53 vertically provided from the back surface of the top plate cover part 31 abut on the front surface of the top plate 20 (see FIG. 4).

Moreover, in a state where the cover member 30 is attached to the top plate 20 via the annular frame 15, the seal flange 37 elastically abuts on the surface of the fuel tank 1. At this time, the seal flange 37 is easily elastically deformed by reducing, by the notch 37a (see FIG. 8), the reaction force received from the tank surface when the seal flange 37 abuts on the surface of the fuel tank 1, the notch 37a being formed on the outer periphery of the base end part of the seal flange 37. As a result, even when the fuel tank is deformed due to pressure fluctuation or the like caused by temperature, the seal flange 37 is elastically deformed as appropriate, so that a state in contact with the surface of the fuel tank 1 can be maintained Therefore, the peripheral edge part 35 of the top plate cover part 31 can be retained at a predetermined position, and the outer peripheral edge part 15b of the annular frame 15 can be restrained from being detached from the fitting recessed part 35b.

When the connector 7 is connected to the first connection part 23, the movable part 47 of the first cover part 45 is moved in the separating direction with respect to the front surface of the top plate cover part 31. Then, in this first cover part 45, the movable part 47 is elastically deformed and turned up so as to have a flat shape with respect to the fixed part 46 via the fragile part 48 as illustrated in FIG. 9, and when the movable part 47 is further moved in the direction approaching the fixed part 46, the movable part 47 is moved so as to be folded back as illustrated in FIG. 6, and the first connection part 23 is exposed.

In this state, as illustrated in FIG. 6, the connector 7 with the checker 7a is connected to the first connection part 23. When the connection between the connector 7 and the first connection part 23 is completed, the checker 7a is enabled to be removed, and thus the checker 7a is removed. Thereafter, as illustrated in FIG. 7, by moving the movable part 47 in the approaching direction with respect to the front surface of the top plate cover part 31, the first connection part 23 and a part of the connector 7 connected thereto can be covered with the movable part 47.

On the other hand, also when the connection member such as the electrical connector is connected to the second connection part 25, by moving the movable part 57 of the second cover part 55 in the separating direction with respect to the front surface of the top plate cover part 31, the movable part 57 is elastically deformed so as to be turned up via the base end part 58, and the second connection part 25 is exposed. Thereafter, after the connection member such as the electrical connector is connected to the second connection part 25, the movable part 57 is moved in the approaching direction with respect to the front surface of the top plate cover part 31, which makes it possible to cover the second connection part 25 and the connection member such as the electrical connector connected thereto with the movable part 57.

Thus, in this protection structure, as described above, after the cover member 30 is attached so as to cover the top plate 20 and the connection parts 23, 25 in the state where the connection parts 23, 25 protrude from the hole parts 39, 41 of the cover member 30, the movable parts 47, 57 of the cover parts 45, 55 are moved in the separating direction from the front surface side of the top plate cover part 31 to expose the cover parts 45, 55, which makes it possible to connect the connection members such as the connector 7 and the electrical connector to the connection parts 23, 25, respectively. Therefore, the cover member 30 can be easily attached as compared with a case where the top plate cover part and the connection-part cover part are separate bodies, and are separately attached.

Moreover, as described above, after the connection members such as the connector 7 and the electrical connector are connected to the connection parts 23, 25, the movable parts 47, 57 are moved in the approaching direction with respect to the front surface side of the top plate cover part 31, which makes it possible to cover the first connection part 23 and the connector 7, and the second connection part 25 and the connection member such as the electrical connector with the cover parts 45, 55. Therefore, the connection parts 23, 25 and a part of the connection members connected thereto can be protected, and the inflow of a liquid containing strong acid such as a vehicle cleaning liquid, a rust removing agent, or a brake cleaner can be suppressed.

Moreover, in this embodiment, as illustrated in FIG. 6, when the movable part 47 of the first cover part 45 is moved in the separating direction from the front surface side of the top plate cover part 31, the movable part 47 can be moved with respect to the fixed part 46 via the fragile part 48 having a lower rigidity. Therefore, since the movable part 47 of the first cover part 45 can be easily moved, connection workability of the connector 7 with respect to the first connection part 23 can be enhanced.

Further, in this embodiment, at least the movable parts 47, 57 of the cover parts 45, 55 are formed of an elastic material. Therefore, when the movable parts 47, 57 are moved, the movable parts 47, 57 can be moved so as to be turned up in the separating direction from the front surface side of the top plate cover part 31 by using the elasticity, so that the connection parts 23, 25 can be easily exposed.

Moreover, in this embodiment, as illustrated in FIGS. 3 and 9, the wall part 49 having a height higher than the front surface of the top plate cover part 31 is erected on the front-side peripheral edge of the first hole part 39. Therefore, even if a liquid such as a cleaning agent attempts to flow into the first hole part 39 from a gap between the movable part 47 and the front surface of the top plate cover part 31, the liquid can be blocked by the wall part 49, so that the inflow of the liquid into the first hole part 39 can be suppressed.

Further, as shown in FIG. 4, the top plate cover part 31 is disposed with the gap with respect to the top plate 20, and the plurality of ribs 53 extending toward the top plate 20 and abutting on the front surface side of the top plate 20 are provided on the back surface side of the top plate cover part 31 and in the vicinity of the wall part 49. Therefore, even if the vicinity of the wall part 49 is pressed by an external force or the like, the plurality of ribs 53 abut on the front surface side of the top plate 20, and receives the external force or the like, so that deformation of the wall part 49 can be suppressed. As a result, it is possible to suppress the inflow of the liquid into the first hole part 39 more reliably.

Note that the present invention is not limited to the above-described embodiments, and various modifications can be made within the scope of the gist of the present invention, and such embodiments are also included in the scope of the present invention.

### REFERENCE SIGNS LIST

1 fuel tank
5 opening part
7 connector (connection member)
10 fuel pump
15 annular frame
20 top plate
21 pump connection pipe
23 first fuel pump connection part (first connection part)
25 second fuel pump connection part (second connection part)
30 cover member
31 top plate cover part
37 seal flange
39 first hole part
41 second hole part
45 first connection-part cover part (first cover part)
46 fixed part
47 movable part
48 fragile part
49 wall part
53 rib
55 second connection-part cover part (second cover part)
57 movable part

1. A protection structure for protecting a fuel pump connection part of a connection member connected to a fuel pump disposed inside a fuel tank via the fuel pump connection part, the protection structure comprising:
a top plate that covers an opening part of the fuel tank and includes the fuel pump connection part; and
a cover member that covers the top plate and the fuel pump connection part, wherein
the cover member includes a top plate cover part that covers the top plate, a hole part that is formed in this top plate cover part and through which the fuel pump connection part protrudes, and a connection-part cover part that extends from this hole part so as to cover the fuel pump connection part and the connection member connected to the fuel pump connection part,
the top plate cover part and the connection-part cover part are integrally formed, and
the connection-part cover part includes a movable part movable in a separating direction and an approaching direction with respect to a front surface side of the top plate cover part, and the fuel pump connection part is exposed in a state where the movable part has moved in the separating direction from the front surface side of the top plate cover part.

2. The protection structure for the fuel pump connection part according to claim 1, wherein a wall part having a height higher than a height of a front surface of the top plate cover part is erected on a front-side peripheral edge of the hole part.

3. The protection structure for the fuel pump connection part according to claim 1, wherein the connection-part cover part includes a fixed part fixed to the top plate cover part, and a fragile part having a lower rigidity than the fixed part and the movable part is provided between the fixed part and the movable part.

4. The protection structure for the fuel pump connection part according to claim 1, wherein at least the movable part is formed of an elastic material.

5. The protection structure for the fuel pump connection part according to claim 2, wherein
the top plate cover part is disposed with a gap interposed with respect to the top plate, and
a rib extending toward the top plate and abutting on a front surface of the top plate is provided on a back surface side of the top plate cover part and in a vicinity of the wall part.

6. The protection structure for the fuel pump connection part according to claim 2, wherein the connection-part cover part includes a fixed part fixed to the top plate cover part, and a fragile part having a lower rigidity than the fixed part and the movable part is provided between the fixed part and the movable part.

7. The protection structure for the fuel pump connection part according to claim 2, wherein at least the movable part is formed of an elastic material.

8. The protection structure for the fuel pump connection part according to claim 3, wherein at least the movable part is formed of an elastic material.
